(19) United States
(12) Patent Application Publication
(10) Pub. No.: US 2014/0116956 A1
(43) Pub. Date: May 1, 2014

(54) CO-PROCESSING OF FLUID FINE TAILINGS AND FRESH OIL SANDS TAILINGS

(71) Applicant: SYNCRUDE CANADA LTD. in trust for the owners of the Syncrude Project, Fort McMurray (CA)

(72) Inventors: SIMON YUAN, Edmonton (CA); RON SIMAN, Edmonton (CA)

(73) Assignee: SYNCRUDE CANADA LTD. in trust for the owners of the Syncrude Project Fort McMurray, Fort McMurray (CA)

(21) Appl. No.: 14/061,523

(22) Filed: Oct. 23, 2013

Related U.S. Application Data
(60) Provisional application No. 61/719,471, filed on Oct. 28, 2012.

(51) Int. Cl. C02F 1/56

(52) U.S. Cl. CPC C02F 1/56
USPC 210/710

(57) ABSTRACT

A process is provided for dewatering fluid fine tailings, comprising combining fluid fine tailings with fresh oil sands tailings to create a tailings mixture having a sand to fines ratio of about 1.0 to about 2.0; optionally diluting the tailings mixture with water to an optimal density; adding an aqueous polymeric flocculant to the tailings mixture and mixing the polymeric flocculant and tailings mixture to form a flocculated material; and transferring the flocculated material to a deposition cell for dewatering.

### FIELD OF THE INVENTION

The present invention relates to a process for treating fluid fine tailings. In particular, the present invention is related to the co-processing of fluid fine tailings and fresh oil sands tailings.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of both coarse tailings composed of water, coarse sand, silt and clay particles and fine tailings composed of fine silts, clays, residual bitumen and water (referred to herein, either separately or combined, as “fresh oil sands tailings”). Mineral fractions with a particle diameter less than 44 microns are referred to as “fines.” These fines are typically clay mineral suspensions, predominantly kaolinite and illite.

The fine tailings suspension is typically 85% water and 15% fine particles by mass. Such fine tailings are generally referred to as “fluid fine tailings” or “FFT”. “Fluid fine tailings” are a liquid suspension of oil sand fines in water with a solids content greater than 1% and having less than an undrained shear strength of 5 kPa. The fact that fluid fine tailings (FFT) behave as a fluid and have very slow consolidation rates significantly limits options to reclaim tailings ponds. Dewatering of fine tailings occurs very slowly. When first discharged in ponds, the very low density material is referred to as thin fine tailings. After a few years when the fine tailings have reached a solids content of about 30-35%, they are referred to as mature fine tailings (MFT) which behave as a fluid-like colloidal material. In general, “mature fine tailings” are fluid fine tailings with a low sand to fines ratio, i.e., less than about 0.3, and a solids content greater than about 30% (nominal). “Sand to fines ratio (SFR)” is defined as the mass ratio of sand to fines, i.e., the mass of mineral solids with particle size >44 μm divided by the mass of mineral solids with particle size ≦44 μm. “Sand” is defined as mineral solids with a particle size greater than 44 μm.

One approach to disposal/management of FFT is the Composite Tailings (CT) process, which involves mixing a coarse tailings stream (e.g., sand) with an FFT stream and adding a coagulant such as gypsum to form slurry that rapidly releases water when deposited and binds the FFT in a coarse tailings/FFT deposit. Thus, more of the fines can be stored in a geotechnical soil matrix, which reduces the inventory of fluid-fine tails and enables a wider range of reclamation alternatives. Hence, CT causes the tailings to settle faster, enabling the development of landscapes that support grass, trees and wetlands. Composite tailings are often referred to as “non-segregating” tailings, meaning that the fines do not readily separate from the coarser sand.

The theory behind CT is to intersperse fines in a sand matrix. Thus, sand is the continuous phase or skeleton and the fines are dispersed throughout the sand matrix. However, this requires mixing FFT and sands at a sand to fines ratio (SFR) of 4:1 to 3:1 (i.e., 20-25% −44 μm fines). Then a coagulant such as gypsum is added to bind the fines to the sand matrix Thus, the amount of sand required for making CT is at the same order of magnitude as that which exists in the oil sand ores. In addition, CT competes with sands demand for constructions of tailings deposition cells and dykes. Hence, the availability of sands restricts the CT production.

CT is designed to contain an average of 20% fines at a solids content of about 60%. Thus, the “coarse solids” stream used to produce CT is obtained by hydro-cycloning whole tailings from the extraction plant, i.e., fresh oil sand tailings, which removes excess water and some fines. Thus, the cyclone sand underflow is nominally at 68% solids content. FIG. 1 (Prior Art) is a process flow diagram of the CT process currently used. Coarse tailings are generally the underflow obtained from a primary separation vessel during oil sands extraction. The coarse tailings are then subjected to a series of hydrocyclones, where the underflow containing the concentrated coarse tailings is mixed using one or more mixers with FFT (e.g., MFT obtained from tailings ponds) to give a SFR of between about 3.0 to about 4.0 and a density (total solids content) of about 60%. Gypsum (a coagulant) is added to the mixers and the CT is then deposited for dewatering in a deposition cell.

Another approach to disposal/management of FFT recently developed by the applicant involves treating FFT with a coagulant and/or a flocculant to form flocs that can be centrifuges to form a centrifuge cake having about 55% solids at a flocculant dosage of 1000 g/t. However, the SFR of the centrifuge cake is 0˜0.1 and, therefore, the FFT centrifuge cake consolidates slowly. Freeze-thaw was found to be the primary and desiccation and under-drainage the secondary processes for cake strength gain.

### SUMMARY OF THE INVENTION

It was surprisingly discovered that the very high sand to fines ratio (SFR) of 4:1 to 3:1 that is required for CT technology could be overcome by instead combining FFT with fresh oil sands tailings and then subjecting the combined FFT/fresh tailings to flocculation using a polymeric flocculant. The fresh oil sand tailings do not need to be hydro-cycloned first, as it was discovered that, in the present invention, a much lower SFR is required. Thus, in one aspect, the present invention is directed to directly combining fresh oil sand tailings with FFT to form non-segregating tailings that can consolidate quicker than some other FFT treatments currently used. Hence, in one aspect, a process is provided for dewatering fluid fine tailings, comprising:
combining fluid fine tailings with fresh oil sands tailings to create a tailings mixture having a sand to fines ratio of about 1.0 to about 2.0;
optionally diluting the tailings mixture with water to an optimal density;
adding an aqueous polymeric flocculant to the tailings mixture and mixing the polymeric flocculant and tailings mixture to form a flocculated material; and
transferring the flocculated material to a deposition cell for dewatering.
   In one embodiment, the flocculated material consolidates to about 55 wt % solids in months.

Without being bound to theory, it is believed that the addition of fresh oil sand tailings to the FFT to form a mixture having a SFR of 1˜2.0 enhances the permeability and the strength of the deposit. Therefore, the deposit with 1˜2.0 SFR would consolidate faster than an FFT deposit with 0˜0.1 SFR. In this way, the co-disposal of fresh tailings and FFT can capture the fines from legacy FFT (i.e., MFT) and the new fines from the oil sand extraction fresh tailings. It is believed that, by using a polymeric flocculant such as an anionic polyacrylamide, it binds the fines such as clay together to form large flocs, thereby forming a fines matrix or skeleton that can then trap the sand to form a non-segregating composite.

In one embodiment, the polymeric flocculant and tailings mixture are mixed during transport through a pipeline by means of in-line static mixers. In another embodiment, the polymeric flocculant and tailings mixture are mixed in a dynamic mixer. In yet another embodiment, the polymeric flocculant and tailings mixture are mixed in a thickener, whereby the thickener underflow is deposited to a deposition site or cell by center discharge, feed well or other deposition methods.

In one embodiment, the polymer is a high molecular weight anionic polymer. In another embodiment, the polymer is a high molecular weight polyacrylamide-sodium polyacrylate unbranched co-polymer. In another embodiment, the polymer is a high molecular weight branched polyacrylamide-sodium polyacrylate co-polymer.

In one embodiment, the tailings mixture (feed) has a total solids content (coarse solids and fines) of about 5% to about 20%, an SFR of about 1.0 to about 2.0 and a polymer dosage of about 200 to about 250 g/tonne solids is used. In another embodiment, the tailings mixture (feed) has a total solids content (coarse solids and fines) of about 13% to about 20%, an SFR of about 1.0 to about 2.0 and a polymer dosage of about 200 to about 250 g/tonne solids is used.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a process flow diagram of Composite Tailings (CT) process of the prior art.

FIG. 2 is a process flow diagram of the co-treatment of FFT with fresh oil sands tailings according to the present invention.

FIGS. 3A, 3B and 3C are schematics showing three embodiments (Option 1(A), Option 2 (B) and Option 3 (C)) of the present invention.

FIG. 4 is a graph showing the initial settling rate (ISR) versus feed sand to fines ratio (SFR) for various mixtures (of fresh tailings and MFT) having a solids content of 5%, 13% and 20% which have been treated according to the present invention.

FIG. 5 is a graph showing the supernatant solids (%) versus feed sand to fines ratio (SFR) for various mixtures (of fresh tailings and MFT) having a solids content of 5%, 13% and 20% which have been treated according to the present invention after 10 minutes of settling.

FIG. 6 is a graph showing settlement solids (%) versus feed sand to fines ratio (SFR) for various mixtures (of fresh tailings and MFT) having a solids content of 5%, 13% and 20% which have been treated according to the present invention.

FIG. 7 is a graph showing segregation defined as the second layer volume/g fines, ml/g, versus feed sand to fines ratio (SFR) for various mixtures (of fresh tailings and MFT) having a solids content of 5%, 13% and 20% which have been treated according to the present invention.

FIG. 8 is a graph showing the sediment yield stress, Pa, versus feed sand to fines ratio (SFR) for various mixtures (of fresh tailings and MFT) having a solids content of 5%, 13% and 20% which have been treated according to the present invention.

FIG. 9 is a graph showing the Capillary Suction Time (CST) in seconds versus feed sand to fines ratio (SFR) for various mixtures (of fresh tailings and MFT) having a solids content of 5%, 13% and 20% which have been treated according to the present invention.

FIG. 10 is a graph showing the initial settling rate (ISR) versus polymer dose (g/tonne solids) for two mixtures of fresh tailings and MFT, one having a solids content of 13% and the other having a solids content of 20%, to show the effect of polymer A1 dosages on ISR.

FIG. 11 is a graph showing the sediment solids (%) versus polymer dose (g/tonne solids) for two mixtures of fresh tailings and MFT, one having a solids content of 13% and the other having a solids content of 20%, to show the effect of polymer A1 dosages on sediment solids content.

FIG. 12 is a graph showing the sediment yield stress, Pa, versus polymer dose (g/tonne solids) for two mixtures of fresh tailings and MFT, one having a solids content of 13% and the other having a solids content of 20%, to show the effect of polymer A1 dosages on yield stress of sediment.

FIG. 13 is a graph showing the sediment Capillary Suction Time (CST) in seconds versus polymer dose (g/tonne solids) for two mixtures of fresh tailings and MFT, one having a solids content of 13% and the other having a solids content of 20%, to show the effect of polymer A1 dosages on dewatering.

FIG. 14 is a Ternary Diagram showing the comparison of properties of different tailings slurry.

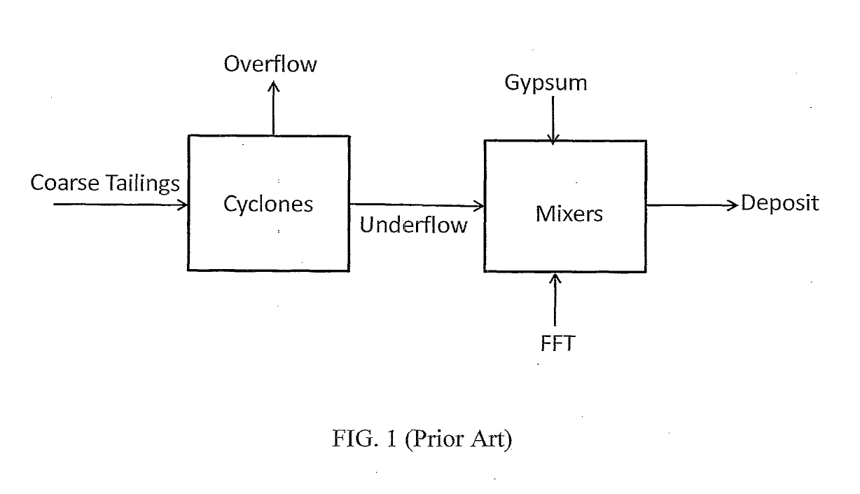

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

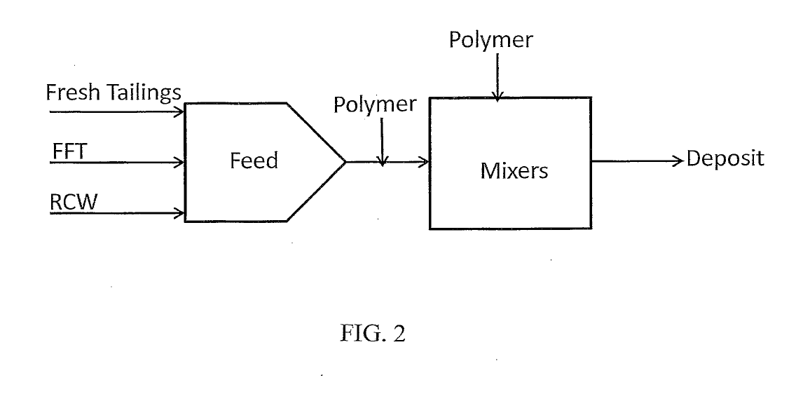

The present invention relates generally to a process that combines the concept of co-disposal of fresh tailings and FFT with modern paste technology, as schematically demonstrated in FIG. 2. Fresh tailings are obtained directly from oil sand extraction, for example, primary and secondary separation vessel tailings and flotation tailings from oil sands extraction plants, and mixed with fluid fine tailings such as mature fine tailings (MFT) to give a tailings mixture with a SFR of about 1˜2.0 and a density (total solids content) greater than about 5%. Optimally, the total solids concentration is greater than about 10%, preferably, between about 13% to about 20%. The mixture may be diluted with water, such as recycle cooling water from tailings ponds (labeled RCW) to the optimal density.

Polymer flocculant may be added during transfer of the feed (fresh tailings, FFT and RCW) to a mixer or series of mixers and/or to the mixers themselves. The flocculated feed is then deposited into deposition cells where dewatering takes place and consolidation of the tailings continues.

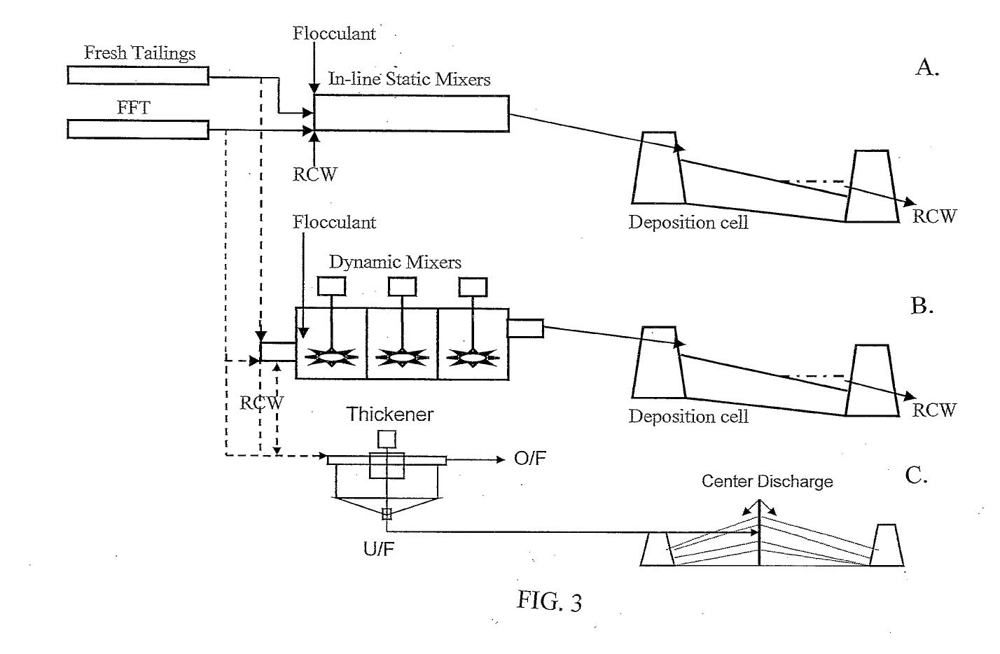

FIGS. 3A and FIG. B show two embodiments of mixers that can be used in the present invention. In Option 1, the tailings mixture is fed to a series of in-line static mixers, as shown in FIG. 3A. In Option 2, dynamic mixers can be used to mix feed with polymer flocculant, as shown in FIG. 3B, where polymer flocculant solution is injected and mixed.

The flocculated materials flow by gravity into a deposition cell where the clear water is decanted at the toe of the deposit and recycled to the RCW ponds while the solids retain and continue to dewater and consolidate in the cell. When the deposition cell is full, the flocculated materials are switched to other deposition cells. The deposit remaining in the previous cell may consolidate to about 55 wt % solids in months. It was surprisingly discovered that in some instances the flocculant dosages were substantially reduced from about 1000 g/t, which is used for FFT centrifuge, to about 100 g/t for the 1˜2.0 SFR mixture.

Option 3, as shown in FIG. 3C, is to use a paste thickener to produce a paste-like thickened tailings (TT) of 55% solids. The TT is pumped to the deposition area and handled with the center-discharge thin-lift stacking technology. It is understood, however, that a filter could also be used to separate the liquid from the solids or centrifugation.

As used herein, the term “flocculant” refers to a reagent which bridges the neutralized or coagulated particles into larger agglomerates, resulting in more efficient settling. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer. Flocculants may be linear or branched.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the flocculant comprises an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred flocculant may be selected according to the FFT composition and process conditions.

The flocculant is supplied from a flocculant make up system for preparing, hydrating and dosing of the flocculant. Flocculant make-up systems are well known in the art, and typically include a polymer preparation skid, one or more storage tanks, and a dosing pump. The dosage of flocculant is controlled by a metering pump. In one embodiment, the dosage of flocculant ranges from about 100 grams to about 1,500 grams per tonne of solids in the FFT. In one embodiment, the flocculant is in the form of a 0.4% solution. In another embodiment, the flocculant is in the form of a 0.3% solution.

### EXAMPLE 1

In this example, a 2-L mixing tank was used for flocculation tests. The tank had a height of 22 cm, with a diameter of 12 cm. A mixer having two 7.5 cm diameter Flat Blades Turbine (FBT, 6 blades) impellers was used to mix the FFT and fresh tailings at a speed of about 300 rpm. Fresh tailings used had a solids content ranging between about 49.5 to about 53.5 wt %, with a SFR ranging from about 4.6 to about 8.5. The FFT used was MFT obtained from tailings ponds, having a solids content ranging from about 36.4 to about 38.6 wt % and a SFR of about 0.01 to about 0.06. Eight different polymers were tested at two polymer dosages of 200 and 250 g/tonne solids. Flocculant solution was injected within a period of 30 seconds via tubing fixed inside the mixing tank and simultaneously mixed with the fresh tailings/MFT slurry.

After flocculation, the flocculated samples were poured out of the mixing tank into a 2-L graduated cylinder for settling testing. The initial settling rate (ISR) of the flocculated tailings were measured for each of the polymers tested and it was determined that the best polymers were those that provided a minimum settling rate of greater than 20 m/hour. A high molecular weight linear anionic polymer comprising a polyacrylamide-sodium polyacrylate co-polymer, hereinafter referred to as polymer “A2”, was chosen to perform the remainder of the tests.

Three feed densities were tested in the following experiments: (1) 5% total solids (i.e., coarse solids+fines); (2) 13% solids; and (3) 20% solids, to determine the optimum feed density. Fresh tailings and FFT mixtures were diluted with recycle water. In general, it was observed that with too high of a feed density, the dosage of polymer required increased and the mixing requirements increased as well. The aim is to find the optimum conditions for quick water release.

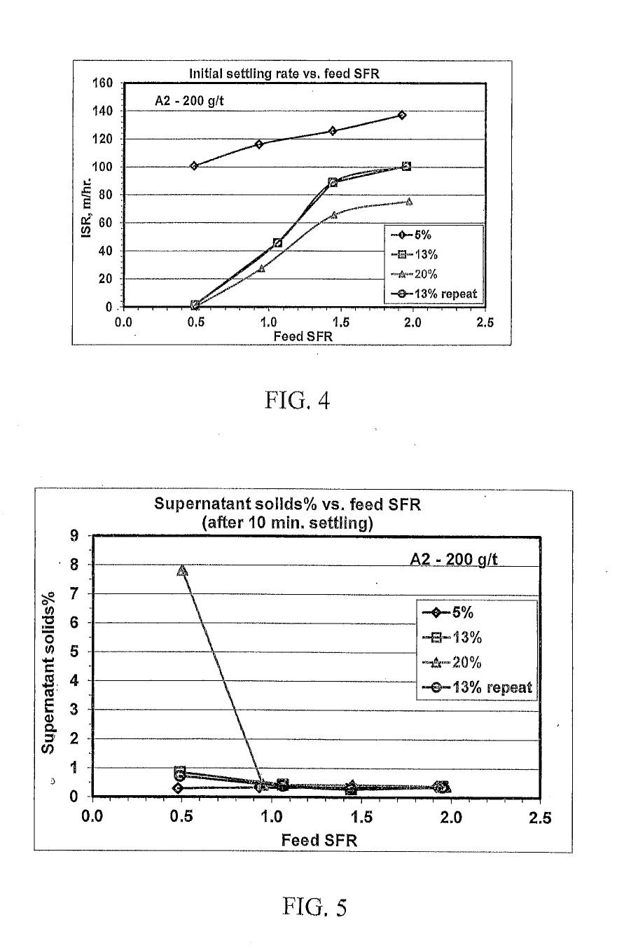

The effects of SFR and feed solids content (i.e., feed density) were tested to determine the most favorable SFR and feed solids content for optimal flocculation. As shown in FIG. 4, the initial settling rate of the flocculated materials increased with increasing SFR for all three slurry densities. This was attributed to more coarse solids trapped inside the flocs, thereby increasing the relative density of the flocs and boosting the settling rate. It was determined that to reach a minimum ISR of 20 m/hour, the SFR should be at least about 1.0 or greater at a flocculant A2 dosage between 200-250 g/tonne. It was also observed that the ISR decreased with increasing solids content in the slurry. This was likely due to hindered settling with increasing solids content in the slurry.

However, it was surprisingly discovered that, in particular with the 20% solids feed, the ISR started to level off at a SFR of about 2.0. Thus, much lower SFR ratios could be used than what were traditionally used with the CT process. The supernatant solids (%) versus feed SFR was also determined after 10 minutes of settling. The results are shown in FIG. 5. It can be seen that the solids content in the supernatant depended upon both the feed solids content and the SFR. To reach a solids content in the supernatant lower than 0.5%, the feed SFR has to be greater than 1.0. All three densities provided similar results with SFR of 1.0 or greater.

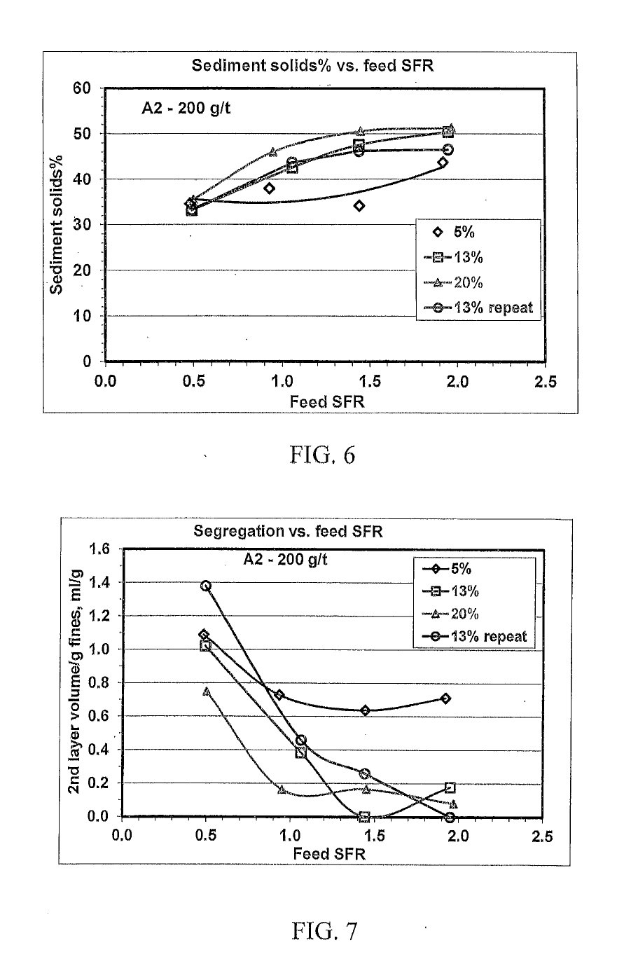

FIG. 6 shows the effect of SFR and feed solids content on sediment solids content. It can be seen that when the solids content in the feed reached about 13% or higher (20%), there was little difference in sedimented solids. However, it was observed that change in the SFR was a determining factor for sediment consolidation. The results indicated that a feed SFR of about 1.5 and feed solids content of about 20% were the best conditions to obtain a 50% solids settlement.

As with CT, the segregation of sediment in tailings treatment is also undesirable. In particular, it is undesirable to have a second layer forming of non-settling solids, in particular, fines. It is desirable to have all of the solids (coarse and fine) settle uniformly. It was discovered that, when using a less dense feed (e.g., 5% vs 20%), there was a much larger second layer formed, indicating segregation. With 5% density, it was observed that segregation could be somewhat reduced by having a higher feed SFR. The results shown in FIG. 7 demonstrate that segregation could be significantly reduced when using a feed with a higher SFR (1.0 or greater) and a higher density feed (13% or greater).

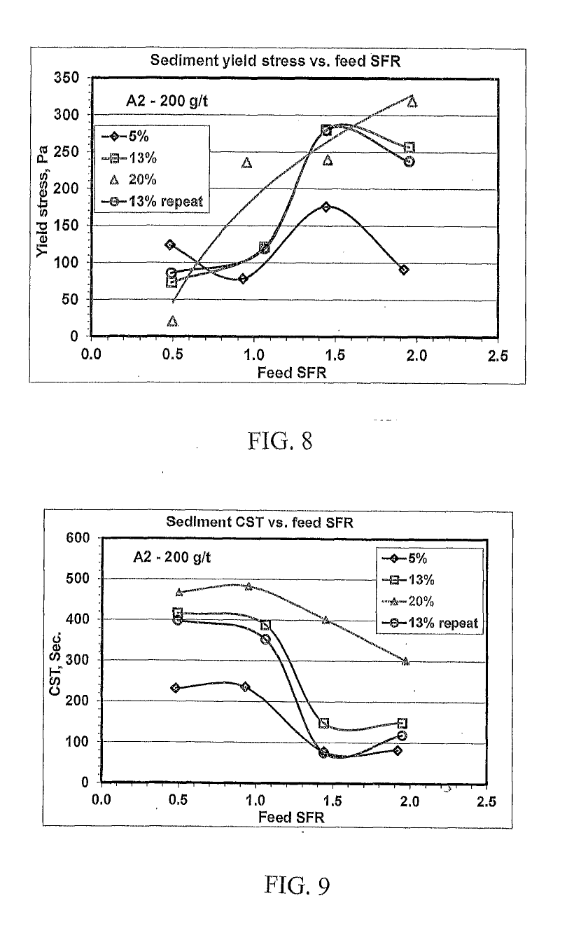

The yield stress of the sediment was measured. Yield stress is a measure of the minimum stress required to deform the sediment plasticity, i.e., the stress required before a material starts to yield. Thus, the higher the yield stress, the stronger the sediment to resist deformation. Yield stress could depend on solids content and the structures of the flocs in the sediment. FIG. 8 shows that a maximum yield stress was observed at a SFR of 1.5 and at a polymer dosage of 200 g/tonne.

The dewatering ability of sediment was also measured using Capillary Suction Time (CST) testers. Dewaterability is measured as a function of how long it takes for water to be suctioned through a filter and low values indicate rapid dewatering whereas high values indicate slow dewatering ability. Thus, a low CST number indicates good dewatering. Dewatering ability is hereinafter referred to as CST. FIG. 9 shows that increasing feed solids content increased CST, likely due to more compacted sediments at higher feed solids content. Once again, it was shown that a CSFR of 1.5 or higher and solids content of 13-20% in the feed could be used to achieve optimal flocculation performance.

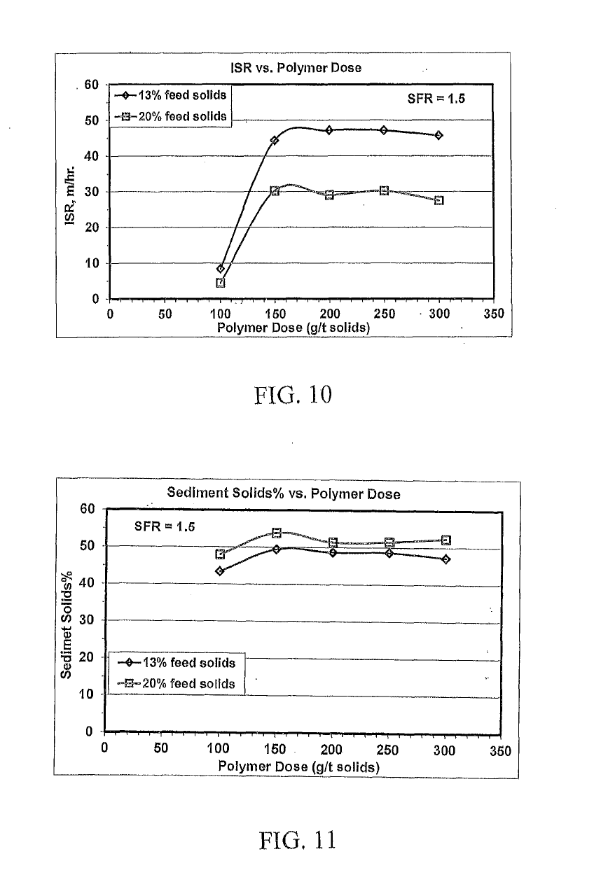

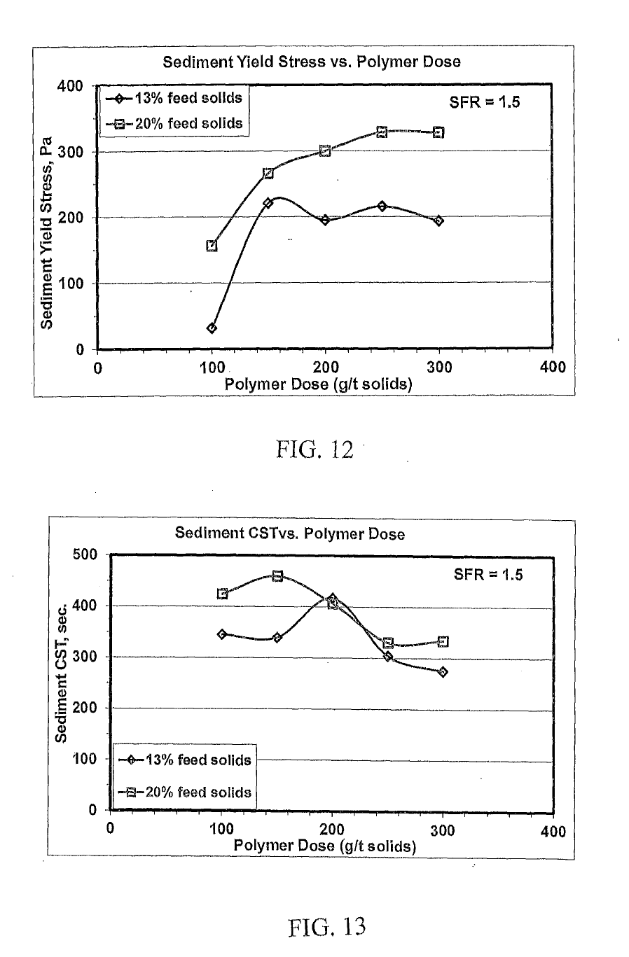

The effect of polymer dosages (A1) on initial settling rates, sediment solids content, sediment yield stress and CST were also tested. FIG. 10 shows that when increasing the A1 polymer dosage from 100 g/tonne to 150 g/tonne of dry solids at a concentration of 0.2 g/L, a significant increase in settling rate was observed. This could indicate the formation of larger or more compact flocs at 150 g/tonne. However, as shown in FIG. 11, the final solids content in the sediment did not change significantly with increasing polymer dosage higher than 100 g/tonne. FIG. 12, however, shows that sediment yield strength increased progressively for samples of 20% solids, suggesting enhanced interactions between the fine solids and polymers at higher polymer dosages. Similarly, better dewaterability was shown with increased polymer dosages. FIG. 13 shows that there was a decrease in sediment CST with increasing polymer dosages, especially when the polymer was higher than 200 g/tonne. The reduction in CST in the sediment with increasing polymer dosages would suggest that the void sizes among the compacted flocs at increased polymer dosages would be larger, thus, entrapped water could be more readily released from the sediment.

### EXAMPLE 2

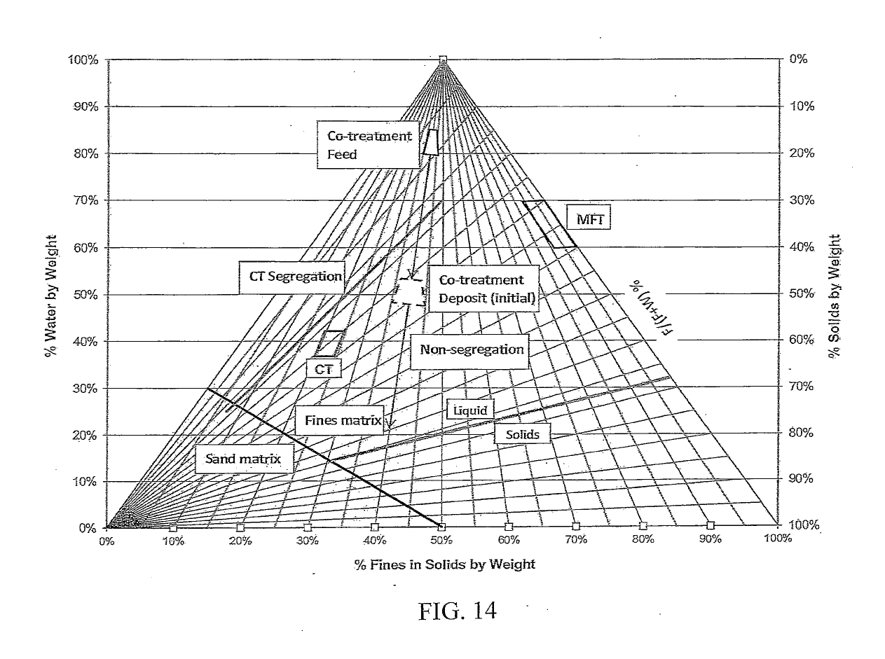

FIG. 14 is a ternary diagram which shows a comparison of properties, % water by weight, % fines in solids by weight, and % solids by weight, of different tailings slurry.

The line directly below the box labeled CT Segregation represents CT (Composite Tailings) −44 um fines segregation boundary line. CT would segregate above this line and would not segregate below this line. The liquid and solid boundary line (the line between the boxes labeled Liquid and Solids) is based on the plastic limits of soils. Here, “liquid” refers to soft tailings while “solid” means semi-solid and solid in nature of soils when the material's density is higher than its plastic limit. The line between the boxes labeled Fines matrix and Sand matrix is the sand and fines matrix boundary line. F/(F+W) is defined as Fines/(Fines+Water) %.

From the ternary diagram, it is clear that the operation envelope of feed density and fines content (i.e., SFR) for co-treatment of FFT and Fresh Tailings by adding polymer is very different from that for CT operation by using gypsum. To make CT in the required operation envelope, hydrocyclones have to be used to enhance the coarse tailings density to about 70-74% solids to make 60% solids CT after mixing 30-35% solids FFT with the hydrocyclone underflow and gypsum. On the other hand, the co-treatment of FFT and Fresh Tailings using polymer does not need hydrocyclones.

The scope of the claims should not be limited by the preferred embodiments set forth in the examples, but should be given the broadest interpretation consistent with the description as a whole.

1. A process for dewatering fluid fine tailings, comprising:
(a) combining fluid fine tailings with fresh oil sands tailings to create a tailings mixture having a sand to fines ratio of about 1.0 to about 2.0;
(b) optionally diluting the tailings mixture with water to an optimal density;
(c) adding an aqueous polymeric flocculant to the tailings mixture and mixing the polymeric flocculant and tailings mixture to form a flocculated material; and
(d) transferring the flocculated material to a deposition cell for dewatering.

2. The process as claimed in claim 1, wherein the flocculated material consolidates to about 55 wt % solids in months.

3. The process as claimed in claim 1, wherein the polymeric flocculant and tailings mixture are mixed during transport through a pipeline by means of in-line static mixers.

4. The process as claimed in claim 1, wherein the polymeric flocculant and tailings mixture are mixed in a dynamic mixer.

5. The process as claimed in claim 1, wherein the polymeric flocculant and tailings mixture are mixed in a thickener, whereby the thickener underflow is deposited to the deposition cell by center discharge, feed well or other deposition methods.

6. The process as claimed in claim 1, wherein a portion of the water is removed from the polymeric flocculant and tailings mixture prior to transferring the mixture to the deposition cell for further dewatering.

7. The process as claimed in claim 6, wherein the portion of the water is removed from the polymeric flocculant and tailings mixture by filtration or centrifugation.

8. The process as claimed in claim 1, wherein the optimal density is between about 5% solids and 20% solids.

9. The process as claimed in claim 1, wherein the optimal density is between about 13% solids and 20% solids.

10. The process as claimed in claim 1, wherein the aqueous polymeric flocculant has a molecular weight ranging between about 1,000 kD to about 50,000 kD

11. The process as claimed in claim 1, wherein the aqueous polymeric flocculant is a high molecular weight anionic polymer.

12. The process as claimed in claim 1, wherein the aqueous polymeric flocculant is a charged or uncharged polyacrylamide.

13. The process as claimed in claim 1, wherein the aqueous polymeric flocculant is a linear or branched high molecular weight polyacrylamide-sodium polyacrylate co-polymer.

14. The process as claimed in claim 1, wherein the aqueous polymeric flocculant is an anionic polyacrylamide having a molecular weight of about 10,000 kD or higher and medium charge density of about 20-35% anionicity.

15. The process as claimed in claim 1, wherein the dosage of aqueous polymer flocculant ranges from about 100 grams to about 1,500 grams per tonne of solids in the fluid fine tailings.

16. The process as claimed in claim 1, wherein the dosage of aqueous polymer flocculant ranges from about 200 grams to about 250 grams per tonne of solids in the fluid fine tailings
